(19) United States
(12) Patent Application Publication
(10) Pub. No.: US 2016/0086233 A1
(43) Pub. Date: Mar. 24, 2016

(54) DISTRIBUTION APPARATUS, DISTRIBUTION METHOD, AND NON-TRANSITORY COMPUTER READABLE STORAGE MEDIUM

(71) Applicant: Yahoo Japan Corpotation, Tokyo (JP)

(72) Inventors: Kazutaka KIMURA, Tokyo (JP); Yuji OHTA, Tokyo (JP); Takashi SHOJI, Tokyo (JP); Wakana KIHARA, Tokyo (JP); Yasuo KOMIYA, Tokyo (JP)

(21) Appl. No.: 14/854,540

(22) Filed: Sep. 15, 2015

(30) Foreign Application Priority Data
Sep. 19, 2014 (JP) 2014-191660

(51) Int. Cl. G06Q 30/02

(52) U.S. Cl. CPC G06Q 30/0277; G06Q 30/0275

(57) ABSTRACT

A distribution apparatus according to the present application includes an accepting unit, a determination unit, and a distribution unit. The accepting unit accepts submission of video content to be displayed in a predetermined content display frame. The determination unit determines display order of the video content based on information indicating users' reactions to the video content accepted by the accepting unit. The distribution unit distributes the video content such that the video content are displayed in the display order determined by the determination unit.

### CROSS-REFERENCE TO RELATED APPLICATION(S)

The present application claims priority to and incorporates by reference the entire contents of Japanese Patent Application No. 2014-191660 filed in Japan on Sep. 19, 2014.

### BACKGROUND OF THE INVENTION

1. Field of the Invention

The present invention relates to a distribution apparatus, a distribution method, and a non-transitory computer readable storage medium having stored therein a distribution program.

2. Description of the Related Art

In recent years, with the dramatic proliferation of the Internet, advertisement distribution through the Internet has been actively performed. For example, advertisement content such as a company and merchandise is displayed in an advertisement frame set on an advertising medium (e.g., a web page). Such advertisement content is, for example, an icon such as a still image, a video content, or text data, and is provided with a hyperlink to a web page provided by an advertiser (hereinafter, referred to as advertiser page).

As a technique for such advertisement distribution, there is proposed a technique in which, when there are a plurality of pieces of advertisement content that can be displayed in the same advertisement frame, a priority order for display in the advertisement frame is determined based on the cost per second which serves as bids accepted from advertisers (see, for example, Japanese Patent Application Laid-open No. 2013-57918).

However, the above-described conventional technique does not always enable to improve advertising effects and perform efficient advertisement distribution. Specifically, the above-described conventional technique merely provides a mechanism in which target keywords for advertisement distribution which are set for an ad are checked against, for example, keywords extracted from web pages browsed by users or keywords inputted on web pages by users, and when the keywords match, the ad is distributed. Therefore, the above-described conventional technique does not always enable to improve advertising effects and perform efficient advertisement distribution.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a display order determination process according to an embodiment;

FIG. 2 is a diagram illustrating an exemplary configuration of a distribution apparatus according to the embodiment;

FIG. 3 is a diagram illustrating an example of a bid information storage unit according to the embodiment;

FIG. 4 is a diagram illustrating an example of an index information storage unit according to the embodiment;

FIG. 5 is a flowchart illustrating a procedure for a display order determination process performed by the distribution apparatus according to the embodiment; and

FIG. 6 is a hardware configuration diagram illustrating an example of a computer that implements the functions of the distribution apparatus.

### DETAILED DESCRIPTION OF THE PREFERRED EMBODIMENTS

A mode (hereinafter, referred to as “embodiment”) for implementing a distribution apparatus, a distribution method, and a distribution program according to the present application will be described in detail below with reference to the drawings. Note that an advertisement apparatus, an advertising method, and an advertising program according to the present application are not limited to those of the embodiment. Note also that, in the following embodiments, the same parts are denoted by the same reference signs and an overlapping description is omitted.

1, Display Order Determination Process

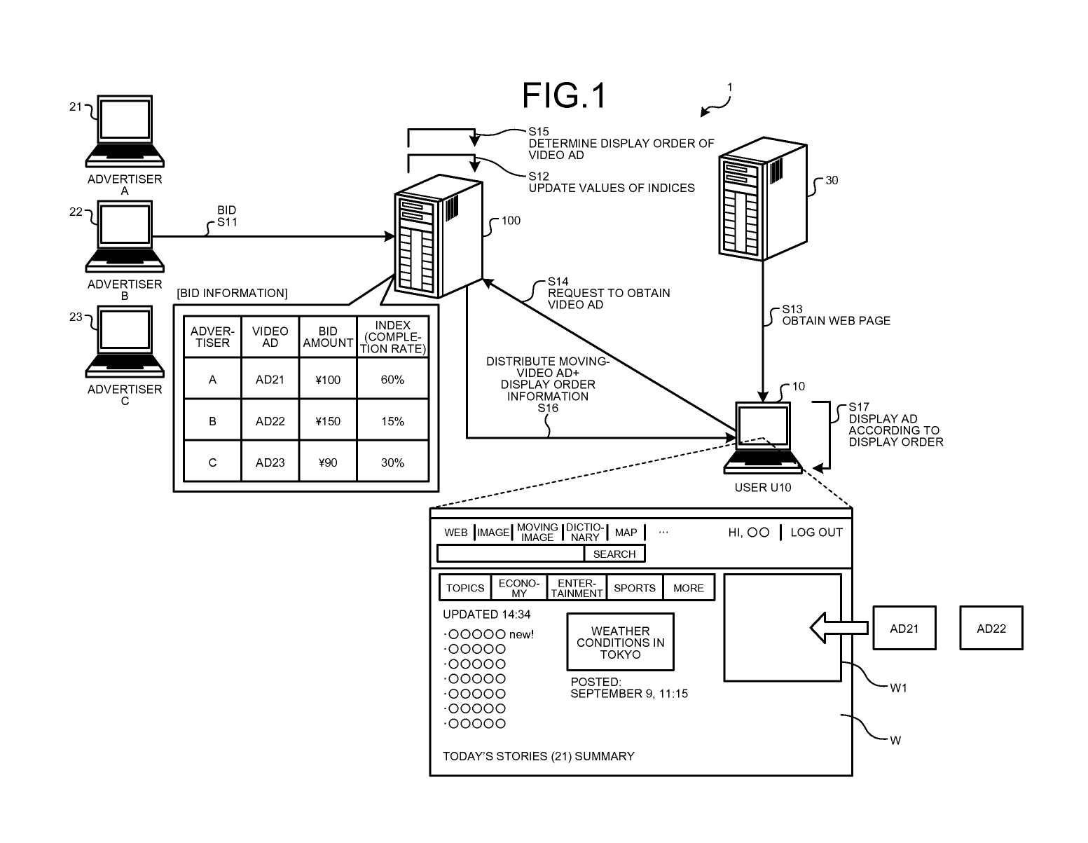

First, using FIG. 1, an example of a display order determination process according to an embodiment will be described. FIG. 1 is a diagram illustrating an example of a display order determination process according to an embodiment. FIG. 1 illustrates an example in which a distribution apparatus 100 determines the display order of advertisement content to be displayed in a content display frame.

As illustrated in FIG. 1, a distribution system 1 includes a user terminal 10, an advertiser terminal 21, an advertiser terminal 22, an advertiser terminal 23, an information providing apparatus 30, and the distribution apparatus 100. The user terminal 10, the advertiser terminal 21, the advertiser terminal 22, the advertiser terminal 23, the information providing apparatus 30, and the distribution apparatus 100 are connected by wire or wirelessly to each other through a network so that they can communicate with each other. Note that the distribution system 1 illustrated in FIG. 1 may include a plurality of user terminals 10. Note also that although FIG. 1 illustrates three advertiser terminals, the configuration is not limited to this example.

The user terminal 10 is an information processing apparatus, e.g., a desktop PC (Personal Computer), a notebook PC, a tablet terminal, a mobile phone, or a PDA (Personal Digital Assistant). For example, the user terminal 10 obtains a web page from the information providing apparatus 30 by accessing the information providing apparatus 30, and displays the obtained web page on a display apparatus (e.g., a liquid crystal display). In addition, when the web page contains an advertisement frame, the user terminal 10 obtains advertisement content from the distribution apparatus 100 by accessing the distribution apparatus 100, and displays the obtained advertisement content on the web page. Note, however, that the configuration is not limited to this example, and the user terminal 10 may obtain a web page containing advertisement content from the information providing apparatus 30. In this case, the information providing apparatus 30 distributes a web page having embedded therein advertisement content which is distributed by the distribution apparatus 100, to the user terminal 10.

The advertiser terminals 21 to 23 are information processing apparatuses used by advertisers that request the distribution apparatus 100 for advertisement distribution. The advertiser terminals 21 to 23 bid on advertisement content, etc., against the distribution apparatus 100, according to operations performed by the advertisers. Note that it is assumed that the advertiser terminals 21 to 23 according to the embodiment bid on video ad advertisement content as advertisement content. In the following, the video advertisement content may be referred to as “video ad”.

In addition, there is also a case in which the advertisers request an agent for submission of video ads, instead of submitting video ads to the distribution apparatus 100 using the advertiser terminals 21 to 23. In this case, the agent submits the video ads to the distribution apparatus 100. In the following, it is assumed that the expression “advertiser” is a concept including not only an advertiser but also an agent, and the expression “advertiser terminal” is a concept including not only an advertiser terminal but also an agent apparatus used by an agent. In addition, since the advertiser terminals 21 to 23 have the same functions, in the following, when the advertiser terminals 21 to 23 do not need to be distinguished from each other, they may be collectively referred to as “advertiser terminal 20”.

The information providing apparatus 30 is, for example, a web server that provides the user terminal 10 with web pages. The information providing apparatus 30 provides various types of web pages related to, for example, news sites, auction sites, weather forecast sites, shopping sites, finance sites, route search sites, map sites, travel sites, gourmet sites, and blogs.

The distribution apparatus 100 according to the embodiment distributes a plurality of video ads at a time which are to be displayed in one display frame. Specifically, the distribution apparatus 100 accepts, as content, video ads to be displayed in a predetermined display frame on a web page, together with pieces of bid information, and determines display order of the accepted video ads, based on information indicating users' reactions to the accepted video ads. Then, the distribution apparatus 100 distributes the video ads at a time such that the video ads are displayed in the determined display order. This will be described using FIG. 1.

In an example of FIG. 1, it is assumed that the distribution apparatus 100 determines display order of video ads to be displayed in a display frame W1 placed on a web page W.

First, the distribution apparatus 100 accepts pieces of bid information each including a video ad and a bid amount, from advertisers (step S11). For example, as illustrated in FIG. 1, it is assumed that the distribution apparatus 100 has accepted pieces of bid information from advertisers A, B, and C. The bid amount indicates the amount of money specified by an advertiser upon submitting a video. In the present embodiment, the bid amount corresponds to the amount of money (e.g., the unit is “yen”) that is charged to an advertiser by a video distributor (e.g., an administrator of the distribution apparatus 100) when a video ad is displayed once.

Specifically, an example is shown in which the distribution apparatus 100 has accepted the bid information “video ad: AD21 and bid amount: 100 yen” from the advertiser A that uses the advertiser terminal 21, the bid information “video ad: AD22 and bid amount: 150 yen” from the advertiser B that uses the advertiser terminal 22, and the bid information “video ad: AD23 and bid amount: 90 yen” from the advertiser C that uses the advertiser terminal 23.

Then, the distribution apparatus 100 performs in advance the process of updating the values of indices indicating users' reactions to each of the accepted video ads (step S12). Note that in the present embodiment the indices include, for example, a completion rate, a social spread rate, a user engagement rate, and a watching rate.

The completion rate indicates the ratio of users' view time to the required time for each video ad accepted by the distribution apparatus 100. The social spread rate indicates the degree of spread of information (e.g., keywords) about each video ad accepted by the distribution apparatus 100, on web pages or social networking services (SNSs). The user engagement rate indicates the ratio of the number of users having performed an audio operation or a screen operation on each video ad accepted by the distribution apparatus 100, to the total number of user terminals having received video distribution (the total number of users having accepted video distribution). The watching rate is a degree indicating how much users' eyes are attracted to each video ad accepted by the distribution apparatus 100, on web pages containing the video ad.

At the point in time when the distribution apparatus 100 has accepted submission of video ads, the value of each index for each of the accepted videos has not yet been determined. Hence, the distribution apparatus 100 performs an update using, for example, the value of each index obtained by methods shown below.

For example, the distribution apparatus 100 separately displays the accepted video ads in a predetermined display frame for a predetermined period, and thereby obtains, for each user terminal 10, a log for the predetermined period about each index. Then, the distribution apparatus 100 calculates the value of each index based on the obtained logs. Alternatively, the distribution apparatus 100 may uniformly display the accepted video ads in a predetermined display frame for a predetermined period in various orders, and thereby obtain, for each user terminal 10, a log for the predetermined period about each index, and then calculate the value of each index based on the obtained logs. Alternatively, for each of the accepted video ads, the distribution apparatus 100 may use values calculated from the past distribution results of video ads of the same category as the video ad. Alternatively, when an advertiser has submitted pieces of other advertisement content in the past, values calculated from the distribution results thereof may be used.

Here, for simplification of description, it is assumed that the distribution apparatus 100 uses the completion rate among the indices. For example, the example of FIG. 1 shows that the distribution apparatus 100 has calculated the completion rate “60%” of the video ad AD21, the completion rate “15%” of the video ad AD22, and the completion rate “30%” of the video ad AD23.

Here, it is assumed that the distribution apparatus 100 has accepted from the user terminal 10 a request to obtain video ads to be displayed in the display frame W1. Specifically, the user terminal 10 obtains a web page W by accessing the information providing apparatus 30, according to an operation performed by a user U10 which is a user of the user terminal 10 (step S13). Then, since the obtained web page W contains a display frame W1, the user terminal 10 requests the distribution apparatus 100 for video ads to be displayed in the display frame W1 (step S14).

Then, the distribution apparatus 100 performs the process of determining display order of video ads to be displayed in the display frame W1 (step S15). Specifically, the distribution apparatus 100 performs the process of determining display order of video ads to be displayed in the display frame W1 among video ads appropriate to the user U10 having requested to obtain video ads.

For example, it is assumed that the distribution apparatus 100 has selected the video ad AD21 and AD22 as video content that satisfy attribute information of the user U10, by matching between user information of the user U10 and targeting conditions set for each video ad. Note that the distribution apparatus 100 does not need to perform matching between user attribute information and targeting conditions.

Then, the distribution apparatus 100 determines display order of the accepted video ads, based on the pre-calculated indices. Specifically, the distribution apparatus 100 multiplies, for each video ad, a corresponding bid amount by the value of an index, and thereby calculates an evaluation value of each video ad. Then, the distribution apparatus compares the calculated evaluation values and thereby determines display order of the video ads in descending order of the numerical values. Note that it is not always necessary for the distribution apparatus 100 to calculate an evaluation value by multiplication of a bid amount by the value of an index. For example, the distribution apparatus 100 may calculate an evaluation value by adding together a bid amount and the value of an evaluation value.

In addition, the distribution apparatus 100 may further assign weights to the index according to a predetermined condition. Then, the distribution apparatus 100 may calculate an evaluation value of each video, using a bid amount and the weighted index.

In the example of FIG. 1, the evaluation value of the video ad AD21 is “100×0.6=60 points” and the evaluation value of the video ad AD22 is “150×15=22.5 points”. Thus, by comparing these evaluation values, the distribution apparatus 100 determines display order of the video ad AD21 and AD22 to be displayed in the display frame W1 such that the video ad AD21 “display order: 1” and the video ad AD22 “display order: 2”.

In addition, the distribution apparatus 100 distributes the video ad AD21 and AD22 at a time to the user terminal U10 such that the video ad AD21 and AD22 which are video ads to be displayed in the display frame W1 are displayed in the determined display order (step S16). For example, the distribution apparatus 100 transmits the video ad AD21 and AD22 and the determined display order information all together to the user terminal 10.

Then, the user terminal 10 displays the video ads received from the distribution apparatus 100 in the display frame W1 on the web page W (step S17). Specifically, the user terminal 10 displays the video ad AD21 and AD22, according to the display order information received from the distribution apparatus 100.

As such, the distribution apparatus 100 accepts submission of video ad and pieces of bid information about the video ads. In addition, the distribution apparatus 100 obtains information indicating users' reactions to each of the accepted video ads. Then, the distribution apparatus 100 determines display order of the video ads to be displayed in a content display frame, based on the obtained information. By this, the distribution apparatus 100 improves advertising effects and performs efficient advertisement distribution.

2. Configuration of the Distribution Apparatus

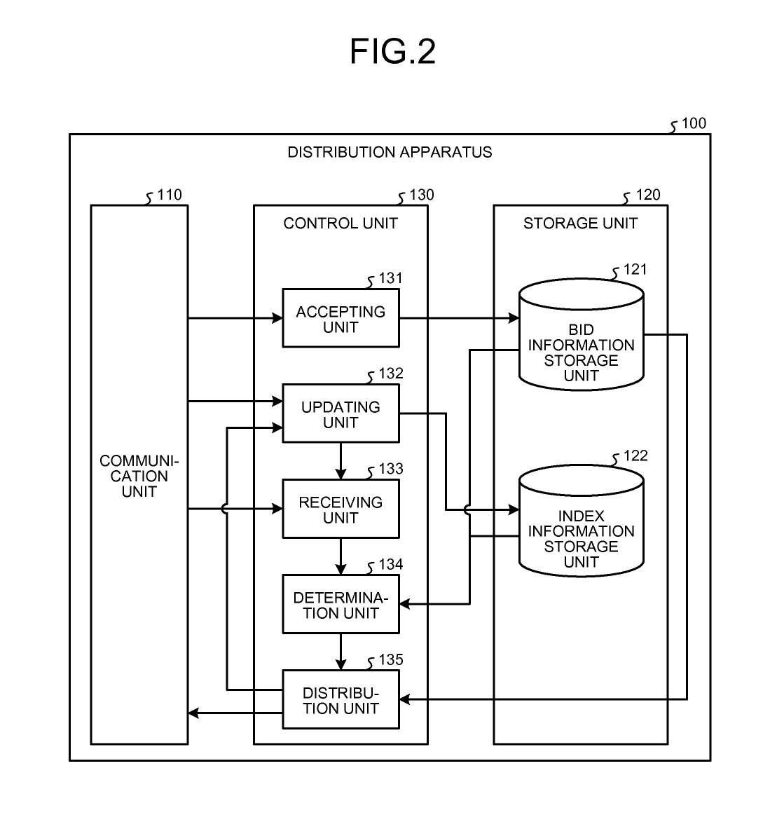

Next, a configuration of the distribution apparatus 100 according to the embodiment will be described using FIG. 2. FIG. 2 is a diagram illustrating an exemplary configuration of the distribution apparatus 100 according to the embodiment. As illustrated in FIG. 2, the distribution apparatus 100 includes a communication unit 110, a storage unit 120, and a control unit 130. Note that the distribution apparatus 100 may include an input unit (e.g., a keyboard and a mouse) that accepts various types of operations from, for example, the administrator that uses the distribution apparatus 100, and a display unit (e.g., a liquid crystal display) for displaying various types of information.

For the Communication Unit 110

The communication unit 110 is implemented by, for example, a NIC (Network Interface Card). The communication unit 110 is connected to a network N by wire or wirelessly, and performs transmission and reception of information with the user terminal 10, the advertiser terminals 20, and the information providing apparatus 30 through the network N.

For the Storage Unit 120

The storage unit 120 is implemented by a storage apparatus, e.g., a semiconductor memory device such as a RAM (Random Access Memory) or a flash memory, or a storage apparatus such as a hard disk or an optical disk. The storage unit 120 includes a bid information storage unit 121 and an index information storage unit 122.

For the Bid Information Storage Unit 121

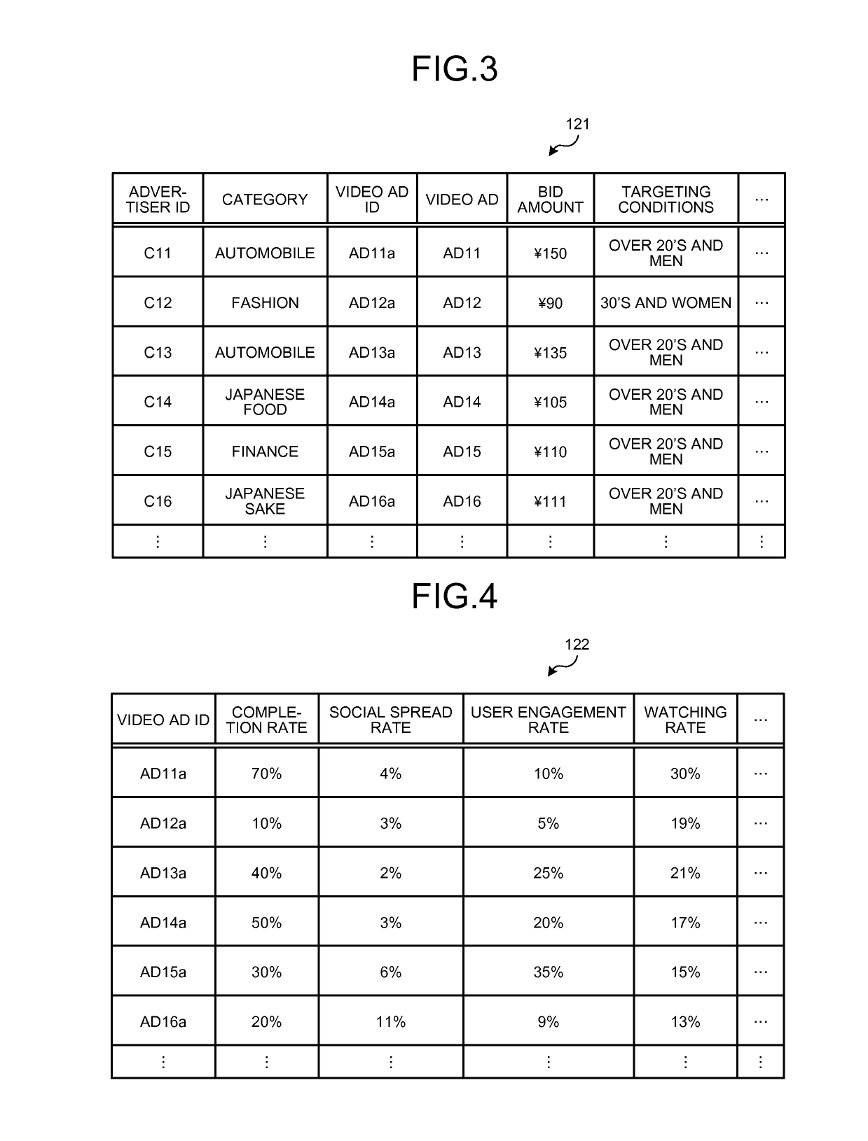

The bid information storage unit 121 stores pieces of bid information including video ads which are submitted from the advertiser terminals 20. Here, FIG. 3 illustrates an example of the bid information storage unit 121 according to the embodiment. In the example illustrated in FIG. 3, the bid information storage unit 121 has items such as an “advertiser ID”, a “category”, a “video ad ID”, a “video ad”, a “bid amount”, and a “targeting conditions”.

The “advertiser ID” indicates identification information for identifying an advertiser or an advertiser terminal 20. The “category” indicates a classification type of a group to which each video ad belongs. For example, the distribution apparatus 100 may allow advertisers to select categories by presenting categories on a dedicated web page for accepting bids from the advertisers, or may allow the advertisers to input categories.

The “video ad ID” indicates identification information that identifies each video ad. In addition, although the example illustrated in FIG. 3 shows that pieces of conceptual information such as AD11 and AD12 are stored in the “video ad”, in practice, pieces of data on video ads are stored. The “bid amount” indicates the amount of money specified by an advertiser when submitting a video ad. In the present embodiment, the “bid amount” corresponds to the amount of money (e.g., the unit is “yen”) that is charged to an advertiser by a video ad distributor (e.g., the administrator of the distribution apparatus 100) when a video ad is displayed once.

The “targeting conditions” is information that is set by an advertiser when submitting advertisement content, and indicates conditions for target users for distribution of the advertisement content. For example, in the “targeting conditions” are stored user attributes of target users for distribution of the advertisement content.

Namely, FIG. 3 illustrates an example in which an advertiser identified by the advertiser ID “C11” has set the category “automobile”, the bid amount “150 yen”, and the targeting conditions “over 20's and men”, and submitted the video ad “AD11” identified by the video ad ID “AD11a”.

For the Index Information Storage Unit 122)

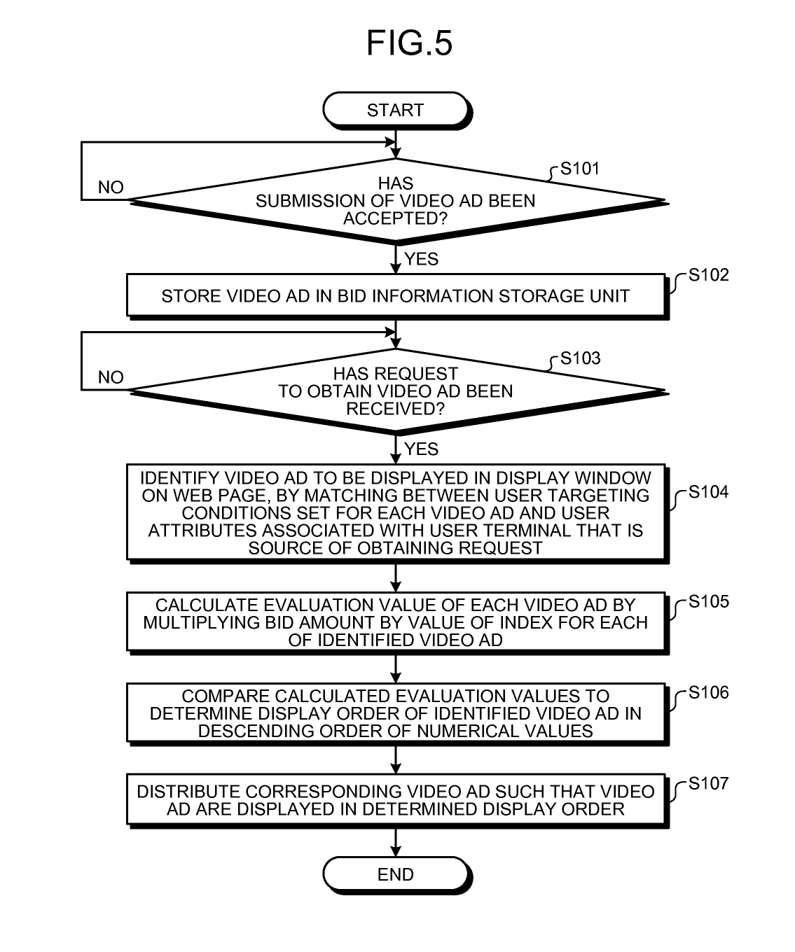

The index information storage unit 122 stores information about indices indicating users' reactions to each video ad accepted by the distribution apparatus 100. Here, FIG. 4 illustrates an example of the index information storage unit 122 according to the embodiment. In the example illustrated in FIG. 4, the index information storage unit 122 stores a “completion rate”, a “social spread rate”, a “user engagement rate”, and a “watching rate” in association with a “video ad ID”.

The “video ad ID” is identification information for identifying each video ad accepted by the distribution apparatus 100, and corresponds to each video ad ID stored in the bid information storage unit 121.

The “completion rate” indicates the ratio of users' view time to the required time for each video ad accepted by the distribution apparatus 100.

The “social spread rate” indicates the degree of spread of information (e.g., keywords) about each video ad accepted by the distribution apparatus 100, on web pages or SNSs. For example, the case of distributing the video ad AD11 by the distribution apparatus 100 is assumed. When statistics are obtained that indicate an increase in the usage rate of keywords related to the video ad AD11 on the Web after the distribution, it can be said that information about the video ad AD11 has spread. Namely, in the present embodiment, the social spread rate may be a degree indicating the spread of keywords on the Web that are related to each video ad accepted by the distribution apparatus 100. In addition, as an SNS, twitter (registered trademark) is shown as an example. For example, it is assumed that a company related to the video ad AD11 has submitted information about the video ad AD11. At this time, it can be said that the larger the number of retweeted people among the followers of the company, the more widely the information about the video ad AD11 has spread. Namely, in the present embodiment, the social spread rate may be a value indicating the degree of followers' reactions on an SNS.

The “user engagement rate” indicates the ratio of the number of users having performed an audio operation or a screen operation on each video ad accepted by the distribution apparatus 100, to the total number of user terminals having received video ad distribution (the total number of users having accepted video distribution). For example, assuming the case of distributing the video ad AD11 by the distribution apparatus 100, the ratio of the number of users having performed an audio operation or a screen operation on the video ad AD11, to the total number of user terminals having received the video ad AD11 is the user engagement rate of the video ad AD11. Note that the audio operation is, for example, the operation of changing a volume from 0 to 1 or more. In addition, the screen operation is, for example, the operation of enlarging and displaying a display screen of a video ad.

The “watching rate” is a degree indicating how much users' eyes are attracted to each video ad accepted by the distribution apparatus 100, on web pages containing the video ad. For example, assuming the case of distributing the video ad AD11 by the distribution apparatus 100, the degree indicating how much users' eyes are attracted to the video ad AD11 on web pages containing the video ad AD11 is the watching rate of the video ad AD11. Note that the watching rate is calculated based on pieces of users' eye information which are obtained by eye cameras, wearables, etc., included in user terminals 10. Note that in the present embodiment the wearable indicates a device where a sensor that measures a potential difference is mounted on an eyeglass frame. The eye camera and the wearable detect eye movements by measuring a potential difference of the eyeball (eye tracking).

For the Control Unit 130

The control unit 130 is implemented by, for example, a CPU (Central Processing Unit), an MPU (Micro Processing Unit), etc., executing various types of programs (corresponding to an example of a distribution program) stored in an storage apparatus in the distribution apparatus 100, using a RAM as a working area. In addition, the control unit 130 is implemented by, for example, an integrated circuit such as an ASIC (Application Specific Integrated Circuit) or an FPGA (Field Programmable Gate Array).

The control unit 130 includes, as illustrated in FIG. 2, an accepting unit 131, an updating unit 132, a receiving unit 133, a determination unit 134, and a distribution unit 135, and implements or executes the functions and actions of information processing which will be described below. Note that the internal configuration of the control unit 130 is not limited to that illustrated in FIG. 2, and may be other configurations as long as the configurations allow to perform information processing which will be described later. Note also that the connection relationship between the processors included in the control unit 130 is not limited to that illustrated in FIG. 2, and may be other connection relationships.

For the Accepting Unit 131

The accepting unit 131 accepts submission of video ads from the advertiser terminals 20, and stores the accepted video ads in the bid information storage unit 121. Specifically, the accepting unit 131 accepts submission of a video ad together with specification of a category, a bid amount, and targeting conditions, and stores, in the bid information storage unit 121, the category, the bid amount, and the targeting conditions in association with the submitted video ad. At this time, the accepting unit 131 also stores, in the bid information storage unit 121, an advertiser ID corresponding to an advertiser which is the submission source of the video ad, and a video ad ID which is identification information of the video ad.

For the Updating Unit 132

The updating unit 132 updates the value of each index stored in the index information storage unit 122. For example, the updating unit 132 obtains, through the communication unit 110, a log for each user terminal 10 for each video ad distributed by the distribution apparatus 100, and analyzes information about each of the above-described indices from the obtained logs, and thereby updates the information stored in the index information storage unit 122.

For example, by performing setting such that Java (registered trademark) is embedded in video ads in advance to automatically transmit to the distribution apparatus 100 logs including pieces of information on operations (e.g., an audio operation and a screen operation) performed on each video ad by users, the updating unit 132 obtains the logs. Then, the updating unit 132 analyzes the obtained logs and thereby calculates completion rates and user engagement rates. In addition, the updating unit 132 calculates spread rates by obtaining various types of history information by accessing other servers.

In addition, by the eye camera or wearable added with the function of transmitting eye information to the distribution apparatus 100, the updating unit 132 obtains pieces of users' eye information for each video ad. Then, the updating unit 132 analyzes the pieces of users' eye information and thereby calculates watching rates.

In addition, the updating unit 132 may perform an update process at any timing. For example, the updating unit 132 may perform an update operation every week. In addition, for the completion rate, the user engagement rate, and the watching rate, the updating unit 132 may use an average value of values calculated on a per user terminal 10 basis.

Now, an update process performed by the updating unit 132 will be described. For an update process performed by the updating unit 132, there are considered the operation of calculating the values of indices whose values have not yet been determined, and updating the index information storage unit 122 using the calculated values; and the operation of calculating the value of each index based on logs for video ads having been displayed in display order which is determined by the determination unit 134 which will be described later, and updating the index information storage unit 122 using the calculated values whenever necessary.

First, an example will be described in which the updating unit 132 updates indices whose values have not yet been determined. For example, at the point in time when video ads are accepted by the distribution apparatus 100, the value of each index has not yet been determined. Hence, for example, by the distribution apparatus 100 distributing each video ad on a trial basis, the updating unit 132 calculates the value of each index based on logs about each video ad which are obtained during a period from the distribution to when a predetermined period has elapsed therefrom. Then, the updating unit 132 updates the index information storage unit 122 using the calculated value of each index.

For example, the distribution apparatus 100 separately displays accepted video ads in a predetermined display frame for a predetermined period. Accordingly, the updating unit 132 obtains, for each user terminal 10, a log for the predetermined period about each index. Then, the updating unit 132 calculates the value of each index based on the obtained logs, and updates the index information storage unit 122 using the calculated values. Alternatively, as another method, the distribution apparatus 100 may uniformly display accepted video ad in a predetermined display frame for a predetermined period in various orders.

In addition, such a process of distributing, by the distribution apparatus 100, each video ad on a trial basis does not necessarily need to be performed. For example, for each of the accepted video ads, the distribution apparatus 100 may use values calculated from the past distribution results of video ads or ads of the same category as the video ad. Alternatively, when an advertiser has submitted pieces of other advertisement content in the past, values calculated from the distribution results thereof may be used. Alternatively, the distribution apparatus 100 may use fixed values which are set arbitrarily.

Next, an example will be described in which the updating unit 132 updates each index by distributing video ads whose display order is determined by the determination unit 134 which will be described later. The distribution apparatus 100 determines display order of video ads to be displayed in a display frame, based on the value of each index updated by the updating unit 132, and distributes the video ads such that the video ads are displayed in the determined display order. By this, the updating unit 132 calculates the value of each index based on logs (e.g., logs for one week) about the video ads having been displayed in the above-described display order, and updates the index information storage unit 122 using the calculated values.

Thereafter, every time the index information storage unit 122 is updated by the updating unit 132, the distribution apparatus 100 performs the process of determining display order, and the updating unit 132 repeats the operation of calculating, every predetermined period, each index based on logs about each video ad which are obtained during that period, and updating the index information storage unit 122 using the calculated values.

Note that the logs about video ads are logs obtained by the updating unit 132, for example, by the above-described Java (registered trademark) function or access to multiple servers by the updating unit 132 or the function of an eye camera or a wearable.

For the Receiving Unit 133

The receiving unit 133 receives a request to obtain videos, from the user terminal 10 or the information providing apparatus 30. For example, the receiving unit 133 receives a request to obtain advertisement content by an HTTP (Hypertext Transfer Protocol) request, etc.

For the Determination Unit 134

The determination unit 134 determines display order of video ads to be displayed in a content display frame, based on index information. Specifically, when the determination unit 134 accepts, through the receiving unit 133, a request to obtain video ads which is made by the user terminal 10, the determination unit 134 calculates an evaluation value of each video ad, using the values of indices of each video ad accepted by the distribution apparatus 100 and a corresponding bid amount. Then, the determination unit 134 determines display order of the video ads to be displayed in the display frame, based on the calculated evaluation values.

In the following, a specific display order determination process performed by the determination unit 134 will be described. It is assumed that, for example, as illustrated in FIG. 1, the determination unit 134 performs a determination process for determining display order of video ads to be displayed in the display frame W1 set on the web page W.

First, it is assumed that the determination unit 134 has accepted, through the receiving unit 133, a request to obtain video ads, from the user terminal 10 used by the user U10. The determination unit 134 performs matching between the targeting conditions set for each of video ads accepted by the distribution apparatus 100 and the user attributes of the user U10. Then, the determination unit 134 identifies video ads set with targeting conditions that satisfy the user attributes.

For example, it is assumed that the determination unit 134 has obtained the user attributes of the user U10 “25 years old and man” from the terminal information of the user terminal 10. In this case, the determination unit 134 accesses the bid information storage unit 121 illustrated in FIG. 3, to perform matching between the targeting conditions set for the stored video ads and the user attributes “25 years old and man”.

In the example of FIG. 3, the targeting conditions set for a video ad AD11, a video ad AD13, a video ad AD14, a video ad AD15, and a video ad AD16 satisfy the user attributes “25 years old and man”. Thus, the determination unit 134 identifies the video ad AD11, the video ad AD13, the video ad AD14, the video ad AD15, and the video ad AD16.

Subsequently, the determination unit 134 calculates evaluation values of the identified video ads. Specifically, the determination unit 134 calculates an evaluation value Eᵢ of a video ad i, using the following equation (1):

Evaluation value Eᵢ=Mᵢ×kᵢ·Gᵢ (1)

Mᵢ indicates a bid amount for the video ad i. In addition, Gᵢ indicates the value of any index among a completion rate, a social spread rate, a user engagement rate, and a watching rate which are indices for the video ad i. In addition, kᵢ indicates a weight by which the index Gᵢ is multiplied. Specifically, the determination unit 134 calculates an evaluation value of each video ad by multiplying a corresponding bid amount by the value of an index.

Note that the determination unit 134 does not necessarily need to use one index when calculating the evaluation value Eᵢ of the video ad i. For example, the determination unit 134 may calculate the evaluation value Eᵢ of the video ad i using all indices. In this case, the determination unit 134 calculates the evaluation value Eᵢ of the video ad i, using the following equation (2):

Evaluation value Eᵢ=Mᵢ×(k₁·G₁+k₂·G₂+k₃·G₃+k₄·G₄) (2)

It is assumed that G₁ to G₄ indicate the values of a completion rate, a social spread rate, a user engagement rate, and a watching rate, respectively, in this order. In addition, k₁ to k₄ indicate weights by which the respective indices are multiplied. Specifically, the determination unit 134 calculates an evaluation value of each video ad by multiplying a corresponding bid amount by the total value of the values of the indices. Then, the determination unit 134 multiplies the value of each index by a weight, as necessary.

Note that though a detailed description is omitted, even when any two or three indices among the values are used, the same idea as equation (2) is used. For example, when the determination unit 134 calculates the evaluation value Eᵢ of the video ad i using the values of two indices such as a completion rate and a social spread rate, the determination unit 134 multiplies a corresponding bid amount by the total value of the values of these indices.

Now, calculation of an evaluation value of each video ad will be described using a specific example. As described above, the determination unit 134 has identified the video ad AD11, the video ad AD13, the video ad AD14, the video ad AD15, and the video ad AD16, as video ads to be displayed in the display frame W1. An example of calculation of an evaluation value of the video ad AD11 performed by the determination unit 134 using a completion rate, a social spread rate, a user engagement rate, and a watching rate is shown.

According to FIG. 4, the values of the indices are as follows: the completion rate “70%”, the social spread rate “4%”, the user engagement rate “10%”, and the watching rate “30%”. In addition, it is assumed that the determination unit 134 has set the weight “1” for the completion rate, the weight “0” for the social spread rate, “1” for the user engagement rate, and “1” for the watching rate. Note that the weights assigned to the indices are values set arbitrarily to simplify computation.

In such a case, using equation (2), the determination unit 134 obtains the evaluation value E_{AD11} “165” by evaluation value E_{AD11}=150×(1×0.7+0×0.04+1×0.1+1×0.3). Then, the determination unit 134 also determines evaluation values of the video ads AD13 to AD16, by the same method. Here, it is assumed that the determination unit 134 has determined the evaluation values of the video ads as follows: “165” for the video ad AD11, “132” for the video ad AD13, “111” for the video ad AD14, “95” for the video ad AD15, and “90” for the video ad AD16.

Subsequently, the determination unit 134 selects a predetermined number of video ads from among the video ads whose evaluation values have been calculated. Then, the determination unit 134 determines display order of the selected video ads, based on the evaluation values. Specifically, the determination unit 134 determines display order in descending order of the evaluation values.

For example, assuming that “4” is preset as the number of video ad to be distributed, the determination unit 134 selects four video ads in descending order of the evaluation values: the video ad AD11, the video ad AD13, the video ad AD14, and the video ad AD15. Note that such selection (selection of video ads with the highest to fourth highest evaluation values) is an example, and thus the determination unit 134 does not necessarily need to select a predetermined number of top video ads with high evaluation values every time. That is, the determination unit 134 does not need to select a predetermined number of top video ads with high evaluation values every time, as video ads to be displayed in the display frame W1, in response to an obtaining request made by the user terminal 10. In such a technique, bias occurs in video ads to be displayed and thus, for example, if the determination unit 134 has selected, for the first obtaining request, a predetermined number of top video ads with high evaluation values, then the determination unit 134 may select, for the second obtaining request, video ads with the highest, third highest, fifth highest, and sixth highest evaluation values. In addition, the determination unit 134 does not necessarily need to use the highest evaluation value as a reference value. For example, the determination unit 134 may select, for the first obtaining request, video ads with the second, third, fifth, and seventh highest evaluation values, and may select, for the second obtaining request, video ads with the fourth, fifth, seventh, and ninth highest evaluation values.

As such, the determination unit 134 performs setting so as to increase the chance of selecting video ads with evaluation values greater than or equal to a predetermined value, while selecting video ads randomly so as to prevent the occurrence of bias in video ads to be displayed. For example, if the selection is completely random one, then in an extreme case, a situation may occur where a video ad with the tenth highest evaluation value has more chance of being displayed than a video ad with the highest evaluation value. In other words, there is a possibility that many video ads that are considered to be of no interest to the user may be displayed. To avoid this, the determination unit 134 may adopt a technique in which a predetermined threshold value is set for the evaluation value so as to increase the probability of selecting video ads with evaluation values greater than or equal to the threshold value.

Then, the determination unit 134 determines display order in descending order of the evaluation values, For example, the determination unit 134 determines as follows: the video ad AD11 “display order: 1”, the video ad AD13 “display order: 2”, the video ad AD14 “display order: 3”, and the video ad AD15 “display order: 4”.

Subsequently, the determination unit 134 transmits the determined display order and video ad IDs to the distribution unit 135 such that they are associated with each other.

Now, the setting of weights will be described. It is preferred that the determination unit 134 assign weights according to the degree of user interest in each video ad. Specifically, it is preferred that the determination unit 134 assign weights such that a higher evaluation value is set for a video ad that attracts more user attention, so that the video ad can gain a higher position in the display order. By this, the distribution apparatus 100 can superiorly display ads in which users are likely to get interested, and thus, can allow the users to view beneficial video ads and can increase advertising effects.

Specifically, the determination unit 134 can assign weights based on the following idea. For example, the completion rate is the ratio of users' view time to the required time for a video ad, but the view time here is not always precise view time and is merely an estimated value. That is, since, at the point in time when a web page is displayed, a video ad set for the page is automatically played back, the user's stay time on the web page is the view time. There is no conclusive evidence of the user definitely viewing the video ad during the stay time. Hence, it is also considered that the completion rate and the degree of user interest in a video ad have a weak relationship.

For example, when the view time is about 5 seconds for a 30-second video ad, it can be estimated that the video ad is not viewed almost at all. On the other hand, in the case of a view time of 24 seconds, there is a possibility that the user may have viewed some. Thus, the determination unit 134 sets, for example, the weight “1” for a highly set completion rate (e.g., 80% or more). Then, for a completion rate of 80% or less, the determination unit 134 may set a weight at an arbitrarily set attenuation rate such that 0.1 is subtracted from the weight “1” for every 10% decrease in the completion rate.

On the other hand, it can be said that the social spread rate, the user engagement rate, and the watching rate have a strong relationship with the degree of user interest in a video ad.

For example, a user having got interested in the content of a video ad by viewing the video ad may perform a search using keywords related to the video ad or may post information about the video ad on an SNS, by which the social spread rate may be increased. Thus, it can be said that the social spread rate is associated with the degree of user interest. In addition, the user engagement rate is a numerical value related to users having performed operations (a volume operation, a screen operation, etc.) on a video ad, and thus, it can be said that the user engagement rate is associated with the degree of user interest. In addition, it can be said that the watching rate is also a numerical value associated with the degree of user interest.

Thus, for the social spread rate, the user engagement rate, and the watching rate, the determination unit 134, for example, sets the weight “1” for 10%, and adds the weight “0.1” for every 5% increase thereafter.

Note that the above-described weight setting method and weight values are an example, and thus, any weight may be set for each index as long as weights are assigned taking into account user interest.

For the Distribution Unit 135

The distribution unit 135 accesses the bid information storage unit 121 when accepting display order and video ad IDs from the determination unit 134, to obtain video ads associated with the video ad IDs. Then, the distribution unit 135 distributes the obtained video ads to the user terminal 10 such that the video ads are displayed in the display order.

3. Procedure for a Display Order Determination Process

Next, a display order determination process performed by the distribution apparatus 100 according to the embodiment will be described using FIG. 5. FIG. 5 is a flowchart illustrating a procedure for a display order determination process performed by the distribution apparatus 100 according to the embodiment.

As illustrated in FIG. 5, the accepting unit 131 of the distribution apparatus 100 determines whether the accepting unit 131 has accepted submission of a video ad from an advertiser terminal 20 (step S101). Then, if the accepting unit 131 has not accepted submission (step S101; No), the accepting unit 131 waits until accepting submission. On the other hand, if the accepting unit 131 has accepted submission (step S101; Yes), the accepting unit 131 stores the submitted video ad and a category, a bid amount, and targeting conditions which are specified by an advertiser upon the submission, in the bid information storage unit 121 (step S102).

Subsequently, the receiving unit 133 determines whether the receiving unit 133 has received a request to obtain video ads (step S103). Then, if the receiving unit 133 has not received an obtaining request (step S103; No), the receiving unit 133 waits until receiving an obtaining request.

On the other hand, if the receiving unit 133 has received an obtaining request (step S103; Yes), the determination unit 134 performs matching between targeting conditions set for each video ad and the user attributes of a user associated with a user terminal that is the source of the transmission of the obtaining request, and thereby identifies video ads to be displayed in a predetermined display frame W1 on a web page (step S104).

Subsequently, the determination unit 134 multiplies a bid amount by the value of an index for each of the identified video ads, and thereby calculates an evaluation value of each video ad (step S105). Then, the determination unit 134 compares the calculated evaluation values to determine display order of the video ads in descending order of the numerical values (step S106). Note that, when the number of video ads to be displayed in the display frame is predetermined, the determination unit 134 selects such a number of video ads from among the identified video ads, and determines display order of the selected video ads based on the calculated evaluation values.

Then, the distribution unit 135 distributes corresponding video ads such that the video ads are displayed in the display order determined by the determination unit 134 (step S107).

4. Variants

The distribution apparatus 100 according to the above-described embodiment may be implemented in various different modes other than the above-described embodiment. Hence, in the following, other embodiments of the above-described distribution apparatus 100 will be described.

4-1. Selection of Video Ad Taking into Account a Category (1)

In the above-described embodiment, an example is shown in which the determination unit 134 determines display order according to the magnitude of an evaluation value of each video ad which is calculated by multiplying a bid amount by the value of an index. However, the determination unit 134 may determine display order based on a category to which each video ad belongs. Specifically, the determination unit 134 determines whether selected video ads that are arranged in display order according to the evaluation value and that belong to the same category, i.e., video ads considered to have a competitive relationship, are consecutive to each other. Then, if the determination unit 134 determines that video ad belonging to the same category are consecutive to each other, the determination unit 134 determines display order where the video ads are not consecutive to each other. This will be described using FIG. 3.

For example, it is assumed that the determination unit 134 has selected the video ad AD11, the video ad AD13, the video ad AD15, and the video ad AD16, as four video ads to be displayed in the display frame W1. In such a case, assuming that display order according to the evaluation value is such that the video ad AD11 “display order: 1”, the video ad AD13 “display order: 2”, the video ad AD15 “display order: 3”, and the video ad AD16 “display order: 4”, the determination unit 134 determines that the video ad AD11 and the video ad AD13 which belong to the same category “automobile” are consecutive in the display order.

In such a case, it can be estimated that an advertiser C11 of the video ad AD11 and an advertiser C13 of the video ad AD13 are competitors. If video ad having a competitive relationship are thus displayed consecutively, then a user results in comparing the video ad. Accordingly, for example, it may lead to allowing the user to have contradictory impressions on their products.

Hence, in order to avoid such an event, the determination unit 134 determines display order, for example, by allocating, between the video ad AD11 and the video ad AD13 in the display order, a video ad belonging to a category unrelated to the category of the video ads AD11 and AD13 among other selected video ads.

The category of the video ad AD15 is “finance” and thus it can be said that the category is unrelated to “automobile”. Hence, the determination unit 134 determines display order, for example, such that the video ad AD11 “display order: 1”, the video ad AD15 “display order: 2”, the video ad AD13 “display order: 3”, and the video ad AD16 “display order: 4”.

In addition, for example, it is assumed that the determination unit 134 has selected the video ad AD11, the video ad AD12, the video ad AD13, and the video ad AD16, as four video ads to be displayed in the display frame W1. In such a case, assuming that display order according to the evaluation value is such that the video ad AD11 “display order: 1”, the video ad AD12 “display order: 2”, the video ad AD13 “display order: 3”, and the video AD16 “display order: 4”, the determination unit 134 determines that categories having a contrary relationship, i.e., the video ad AD13 belonging to the category “automobile” and the video ad AD16 belonging to the category “Japanese sake”, are consecutive in the display order.

It cannot be said that it is favorable to consecutively display a video ad related to “automobile” and a video ad related to “Japanese sake”. For example, there is a possibility that a user who is going to drive a car from now may think of alcohol.

Hence, in order to avoid such an event, the determination unit 134 determines display order, for example, by allocating, between the video ad AD13 and the video ad AD16 in the display order, a video ad belonging to a category unrelated to the categories of the video ads AD13 and AD16 among other selected video ads.

The category of the video ad AD12 is “fashion” and thus it can be said that the category is unrelated to “automobile” and “Japanese sake”. Hence, it is considered that the determination unit 134 determines display order such that the video ad AD11 “display order: 1”, the video ad AD13 “display order: 2”, the video ad AD12 “display order: 3”, and the video ad AD16 “display order: 4”. However, if doing so, the categories of the video ad AD11 and the video ad AD13 are “automobile”, resulting in display order where identical categories are consecutive to each other. Hence, the determination unit 134 determines display order by allocating a video ad other than the selected video ads. For example, the determination unit 134 may allocate a video ad belonging to a category unrelated to “automobile” and “Japanese sake” from among a set of video ads identified by matching between targeting conditions and user attributes.

Note that at the stage of selecting video ads, the determination unit 134 may exclude video ads belonging to the same category from selection targets.

4-2. Selection of Video Ads Taking into Account a Category (2)

In addition, the determination unit 134 determines whether selected video ads that are arranged in display order according to the evaluation value and that belong to categories having a compatible relationship are consecutive to each other. Then, if the determination unit 134 determines that video ads belonging to categories having a compatible relationship are not consecutive to each other, the determination unit 134 determines display order where the video ads are consecutive to each other. This will be described using FIG. 3.

For example, it is assumed that the determination unit 134 has selected the video ad AD12, the video ad AD14, the video ad AD15, and the video ad AD16, as four video ads to be displayed in the display frame W1. In such a case, assuming that display order according to the evaluation value is such that the video AD12 “display order: 1”, the video ad AD14 “display order: 2”, the video ad AD15 “display order: 3”, and the video ad AD16 “display order: 4”, the determination unit 134 determines that the video ad AD14 and the video ad AD16 associated with “Japanese food” and “Japanese sake”, respectively, which are categories having a compatible relationship are not consecutive in the display order.

Here, since “Japanese food” and “Japanese sake” have a compatible relationship, it can be said that, for example, a user having viewed a video ad related to “Japanese food” has a high possibility of thinking of “Japanese sake”. Thus, by consecutively displaying categories having a compatible relationship, it may lead to enhancing user's impressions on both of the video ads by a synergetic effect. By this, for example, advantages such as an improvement in advertising effects can be provided to corresponding advertisers C14 and C16.

Hence, the determination unit 134 determines display order of all of the selected video ads, for example, by changing the position of a video ad present between the video ad AD14 and the video ad AD16 in the display order to a different position, so as to obtain display order where the video ad AD14 and the video ad AD16 are consecutive to each other.

Specifically, the determination unit 134 determines display order of all of the selected video ads by changing the position of the video ad AD15 present between the video ad AD14 and the video ad AD16 in the display order to a higher position than the position of the video ad AD14 or to a lower position than the position of the video ad AD16. For example, the determination unit 134 determines display order of all of the selected video ads by moving the video ad AD15 up one position or down one position in the display order.

In addition, the determination unit 134 may randomly determine whether to move the video ad AD15 up one position or down one position in the display order, or may take into account the evaluation value of the video ad AD15. For example, when taking into account the evaluation value, the determination unit 134 moves the video ad AD15 up one position in the display order when the evaluation value of the video ad AD15 is biased toward the video ad AD14, and moves the video ad AD15 down one position in the display order when the evaluation value of the video ad AD15 is biased toward the video ad AD16.

As such, the distribution apparatus 100 determines display order, taking into account a category to which each video ad belongs. By this, the distribution apparatus 100 can prevent video ads belonging to the same category from being displayed consecutively. By this, the distribution apparatus 100 can avoid one of corresponding advisers from becoming superior for a user. In addition, the distribution apparatus 100 can prevent video ads belonging to categories having a contrary relationship from being displayed consecutively. By this, the distribution apparatus 100 can display video ads so as not to adversely affect on a user. In addition, the distribution apparatus 100 can consecutively display video ads belonging to categories having a compatible relationship. By this, by the synergetic effect of corresponding video ads, the distribution apparatus 100 can improve the profits and advertising effects brought about by the video ads.

4-3. Change of Display Order

In addition, the determination unit 134 dynamically changes, according to information on a user reaction to a video ad being displayed in a predetermined display frame, the positions of video ads in display order which are to be displayed later than the video ad. For example, when a user's watching rate of a video ad being displayed is greater than or equal to a predetermined value, or when information on a user operation (e.g., an audio operation or an enlargement operation) performed on the video ad being displayed is obtained, the determination unit 134 changes determined display order such that a video ad to be displayed next is a video ad having a relationship with the video ad being displayed. This will be described using FIG. 3. Note that it is assumed that the distribution apparatus 100 has a program installed thereon in advance that can obtain, in real time, information of a user reaction to a video ad being displayed. By this, it is assumed that the reaction information is directly transmitted to the determination unit 134 from the user terminal 10 through the communication unit 110.

For example, it is assumed that the determination unit 134 has determined display order of four video ads to be displayed in the display frame W1 on the user terminal 10, taking into account the above-described competition by the same category, such that the video ad AD11 “display order: 1”, the video ad AD12 “display order: 2”, the video ad AD13 “display order: 3”, and the video ad AD14 “display order: 4”.

Here, it is assumed that the determination unit 134 has received information on a user reaction to the video ad AD11 from the user terminal 10. By this, the determination unit 134 determines whether video ads to be displayed later than the video ad AD11 include a video ad having a relationship with the video ad AD11.

If the determination unit 134 determines that video ads to be displayed later than the video ad AD11 include a video ad having a relationship with the video ad AD11, the determination unit 134 changes the display order such that the video ad is displayed after the video ad AD11. Note that the expression “having a relationship” indicates, for example, video ads belonging to the same category or video ads belonging to categories having a compatible relationship.

Here, the determination unit 134 determines that video ads to be displayed later than the video ad AD11 include the video ad AD13 belonging to “automobile” which is the same category as the video ad AD11. Note that even if video ads belong to the same category, the video ads do not always have a competitive relationship. Hence, the determination unit 134, for example, may further determine whether the video ads belonging to the same category have a competitive relationship, based on the content of video ads or company names. If the determination unit 134 determines that the video ads do not have a competitive relationship, the determination unit 134 may perform the display order change process. Here, it is assumed that the video ad AD11 and the video ad AD13 do not have a competitive relationship.

Then, in order to display the video ad AD13 after the video ad AD11, the determination unit 134 moves up the position of the video ad AD13 in the display order and accordingly moves down the positions of the remaining video ads in the display order, and thereby changes the display order of video ads to be displayed later than the video ad AD11 such that the video ad AD13 “display order: 2”, the video ad AD12 “display order: 3”, and the video ad AD14 “display order: 4”.

Subsequently, the determination unit 134 transmits display order information that is changed so as to perform display in the changed display order, to the distribution unit 135. Then, the distribution unit 135 provides an instruction to the user terminal 10, using the display order information changed by the determination unit 134. Note that the setting may be such that the determination unit 134 directly provides an instruction to the user terminal 10 to perform display in the changed display order.

Note that when the video ads to be displayed later than a video ad for which user's reaction information is obtained include a plurality of video ads having a relationship with the video ad for which user's reaction information is obtained, the determination unit 134 may change display order such that a video ad with the highest evaluation value among the plurality of video ads is displayed next, or may change display order such that the plurality of video ads are consecutively displayed based on their evaluation values, after the video ad for which user's reaction information is obtained.

As such, the distribution apparatus 100 changes, according to information on a user reaction to a video ad being displayed, display order of videos to be displayed later than the video ad being displayed. By this, the distribution apparatus 100 can perform video ad distribution according to user needs.

4-4. Video Ad Distribution Method

In the above-described embodiment, an example is shown in which the distribution unit 135 transmits display order information and video ads at a time to a user terminal that has requested to obtain video ads, so as to perform display in display order determined by the determination unit 134. However, the distribution unit 135 may distribute video ads whose display order is determined by the determination unit 134, on a per predetermined number of ads basis, according to user's viewing conditions for a video ad being displayed in a display frame. Specifically, when a user has viewed a video ad being displayed, for a predetermined period of time or more of the required time for the video ad, the distribution unit 135 distributes corresponding video ads on a per predetermined number of ads basis, based on display order determined by the determination unit 134. Note that since a video ad is played back simultaneously with display of a web page, the distribution apparatus 100 may measure a period of time during which the user has viewed a video ad, as user's stay time on a web page where the video ad is displayed.

Here, it is assumed that the setting is performed, for example, such that when the user has viewed 20% or more of the required time for the video ad, the distribution apparatus 100 distributes video ads one by one. In addition, it is assumed that the determination unit 134 has determined, for example, four video ads to be displayed in the display frame W1 on the user terminal 10 and display order thereof such that the video ad AD11 “display order: 1”, the video ad AD12 “display order: 2”, the video ad AD13 “display order: 4”, and the video ad AD14 “display order: 4”.

In such a case, the distribution unit 135 measures user's view time, and at the point in time when the user has viewed 20% of the required time for the video ad AD11, the distribution unit 135 distributes, based on the display order determined by the determination unit 134, the video ad AD12 which is a video ad to be displayed next, to the user terminal 10. In addition, at the point in time when the user has viewed 20% of the required time for the video ad AD12, the distribution unit 135 distributes, based on the display order determined by the determination unit 134, the video ad AD13 which is a video ad to be displayed next, to the user terminal 10. Then, the distribution unit 135 performs such a process on each video ad.

As such, the distribution apparatus 100 distributes video ads whose display order is determined by the determination unit 134, on a per predetermined number of ads basis, according to user's viewing conditions for a video ad. For example, when the distribution apparatus 100 distributes a plurality of video ads at a time to the user terminal 10, problems such as a reduction in processing speed due to a load applied to the user terminal 10 may occur depending on the volume of the video ads. However, by the above-described process, the distribution apparatus 100 can avoid video ads from wastefully consuming the capacity of the user terminal 10.

4-5. Instruction to a User Terminal

When a video ad being displayed on a predetermined web page is stopped and the web page is displayed again, the distribution apparatus 100 may start the video ad from video elapsed time which is obtained at the point in time when the video ad is stopped last time.

For example, it is assumed that the user terminal 10 displays the video ad AD11 in the display frame W1 on the web page W. Here, it is assumed that the display of the video ad AD11 is stopped by a user operation performed, for example, to make the transition from the web page W to another web page. At this time, the distribution apparatus 100 stores the elapsed time of the video ad AD11 which is obtained at the point in time when the display of the video ad AD11 is stopped. Then, when the web page W is displayed again, the distribution apparatus 100 instructs the user terminal 10 to display the video ad AD11 again from the stored elapsed time.

4-6. Selection of a Web Page where Videos are to be Displayed

In addition, the distribution apparatus 100 may select a web page with long user's stay time, and display video ads in a display frame placed on the selected web page.

Specifically, a beacon is embedded in advance in web pages having placed thereon a display frame where video ads accepted by the distribution apparatus 100 are to be displayed. Then, the distribution apparatus 100 obtains video ad display time (user's stay time) for each user terminal on the web pages having the beacon embedded therein. Then, for example, the distribution apparatus 100 calculates average displayed time of each web page during a predetermined period, and selects a web page whose calculated value is greater than or equal to a predetermined value, as a web page where video ads are to be displayed.

It can be said that a web page with longer display time on user terminals has longer users' stay time. Namely, it is highly likely that a web page with long users' stay time is popular among users. By the distribution apparatus 100 selecting such a web page, the possibility of users viewing video ads can be increased.

4-7. Others

The required time for a video ad may be arbitrarily set by each advertiser, but a required-time range may be presented by the distribution apparatus 100 to advertisers. In addition, the display frame may be in an inline format or an overlay format. In addition, in the distribution apparatus 100, the bid format may be a second-price auction format.

4-8. Program

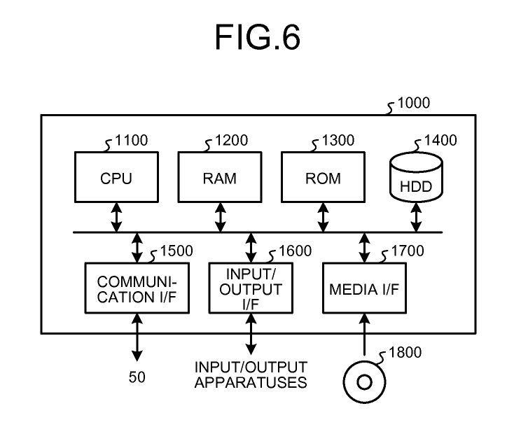

In addition, the distribution apparatus 100 according to the above-described embodiment is implemented, for example, by a computer 1000 having a configuration such as that illustrated in FIG. 6. Description will be made below using the distribution apparatus 100 as an example. FIG. 6 is a hardware configuration diagram illustrating an example of the computer 1000 that implements the functions of the distribution apparatus 100. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates based on a program stored in the ROM 1300 or the HDD 1400, to perform control of each unit. The ROM 1300 stores a boot program which is executed by the CPU 1100 at startup of the computer 1000, a program that depends on the hardware of the computer 1000, etc.

The HDD 1400 stores a program executed by the CPU 1100 and data, etc., which are used by the program. The communication interface 1500 receives data from other devices through a communication network 50 and sends the data to the CPU 1100, and transmits data generated by the CPU 1100 to other devices through the communication network 50.

The CPU 1100 controls output apparatuses such as a display and a printer and input apparatuses such as a keyboard and a mouse, through the input/output interface 1600. The CPU 1100 obtains data from the input apparatuses through the input/output interface 1600. In addition, the CPU 1100 outputs generated data to the output apparatuses through the input/output interface 1600.

The media interface 1700 reads a program or data stored in a recording medium 1800, and provides the program or data to the CPU 1100 through the RAM 1200. The CPU 1100 loads the program onto the RAM 1200 from the recording medium 1800 through the media interface 1700, and executes the loaded program. The recording medium 1800 is, for example, an optical recording medium such as a DVD (Digital Versatile Disc) or a PD (Phase change rewritable Disk), a magneto-optical recording medium such as an MO (Magneto-Optical disk), a tape medium, a magnetic recording medium, or a semiconductor memory.

For example, when the computer 1000 functions as the distribution apparatus 100 according to the embodiment, the CPU 1100 of the computer 1000 executes the program loaded onto the RAM 1200 and thereby implements the functions of the control unit 130. In addition, the data in the storage unit 120 is stored in the HDD 1400. The CPU 1100 of the computer 1000 reads these programs from the recording medium 1800 and executes the programs. However, the CPU 1100 may obtain these programs from another apparatus through the communication network 50 as another example.

5. Effects

As described above, the distribution apparatus 100 according to the embodiment includes the accepting unit, the determination unit, and the distribution unit. The accepting unit 131 accepts submission of video ads to be displayed in a content display frame. The determination unit 134 determines display order of the video ads based on information indicating users' reactions to the video ads accepted by the accepting unit 131. The distribution unit 135 distributes the video ads such that the video ads are displayed in the display order determined by the determination unit 134.

In addition, in the distribution apparatus 100 according to the embodiment, the accepting unit 131 accepts bid amounts for the video ads, and the determination unit 134 determines the display order based on the bid amounts accepted by the accepting unit 131 and values indicating the information.

By this, the distribution apparatus 100 according to the embodiment can improve advertising effects and perform efficient advertisement distribution.

In addition, in the distribution apparatus 100 according to the embodiment, the determination unit 134 determines the display order of the video ads based on categories to which the video ads belong.

By this, the distribution apparatus 100 according to the embodiment can determine display order taking into account a category to which each video ad belongs.

In addition, in the distribution apparatus 100 according to the embodiment, the determination unit 134 determines display order where video ads belonging to categories having a competitive relationship are not consecutive in the display order.

By this, the distribution apparatus 100 according to the embodiment can avoid one of corresponding advisers from becoming superior for a user.

In addition, in the distribution apparatus 100 according to the embodiment, the determination unit 134 determines display order where video ads belonging to categories having a compatible relationship are consecutive in the display order.

By this, the distribution apparatus 100 according to the embodiment can improve advertising effects by the synergetic effect of corresponding video ads.

In addition, in the distribution apparatus 100 according to the embodiment, the determination unit 134 dynamically changes, according to information on a user reaction to a video ad being displayed in the content display frame, display order of video ads to be displayed later than the video ad.

By this, the distribution apparatus 100 according to the embodiment can distribute video ads suitable for a user.

In addition, in the distribution apparatus 100 according to the embodiment, when, as the information on a user reaction to a video ad being displayed in the content display frame, a user's watching rate of the video ad is greater than or equal to a predetermined value, the determination unit 134 dynamically changes the display order such that a video ad having a relationship with the video ad is displayed after the video ad.

By this, the distribution apparatus 100 according to the embodiment can consecutively display a video ad having a relationship with a video ad that is attracting user attention. Accordingly, the distribution apparatus 100 can respond to user needs, enabling to improve advertising effects.

In addition, in the distribution apparatus 100 according to the embodiment, when, as the information on a user reaction to a video ad being displayed in the content display frame, information on a user operation performed on the video ad is obtained, the determination unit 134 dynamically changes the display order such that a video ad having a relationship with the video ad is displayed after the video ad.

By this, the distribution apparatus 100 according to the embodiment can consecutively display a video ad having a relationship with a video ad that is attracting user interest. Accordingly, the distribution apparatus 100 can respond to user needs, enabling to improve advertising effects.

In addition, in the distribution apparatus 100 according to the embodiment, the distribution unit 135 distributes video ads whose display order is determined by the determination unit 134, according to user's viewing conditions for a video ad being displayed in the content display frame.

By this, the distribution apparatus 100 according to the embodiment can smoothly distribute video ads to a user terminal.

In addition, in the distribution apparatus 100 according to the embodiment, when a user has viewed a video ad being displayed in the content display frame, for a predetermined period of time or more of required time for the video ad, the distribution unit 135 distributes video ads whose display order is determined by the determination unit 134, on a per predetermined number of video ads basis.

By this, the distribution apparatus 100 according to the embodiment can smoothly distribute video ads to the user terminal 10. In addition, the distribution apparatus 100 can reduce the load on the user terminal caused by the volume of video ads.

In addition, the above-described “section, module, and unit” can be read as “means”, “circuit”, etc. For example, the determination unit can be read as a determining means or a determination circuit.

According to an aspect of an embodiment, the effect of being able to improve advertising effects and perform efficient advertisement distribution is provided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A distribution apparatus comprising:
an accepting unit that accepts submission of video content to be displayed in a content display frame;
a determination unit that determines display order of the video content based on information indicating users' reactions to the video content accepted by the accepting unit; and
a distribution unit that distributes the video content such that the video content are displayed in the display order determined by the determination unit.

2. The distribution apparatus according to claim 1, wherein
the accepting unit accepts bid amounts for the video content, and
the determination unit determines the display order based on the bid amounts accepted by the accepting unit and values indicating the information.

3. The distribution apparatus according to claim 1, wherein the determination unit determines the display order of the video content based on categories to which the video content belong.

4. The distribution apparatus according to claim 3, wherein the determination unit determines display order where video content belonging to categories having a competitive relationship are not consecutive in the display order.

5. The distribution apparatus according to claim 3, wherein the determination unit determines display order where video content belonging to categories having a compatible relationship are consecutive in the display order.

6. The distribution apparatus according to claim 1, wherein the determination unit dynamically changes, according to information on a user reaction to a video content being displayed in the display frame, display order of video content to be displayed later than the video content.

7. The distribution apparatus according to claim 6, wherein when, as the information on a user reaction to a video content being displayed in the display frame, a user's watching rate of the video content is greater than or equal to a predetermined value, the determination unit changes the display order such that a video content having a relationship with the video content is displayed after the video content.

8. The distribution apparatus according to claim 6, wherein when, as the information on a user reaction to a video content being displayed in the content display frame, information on a user operation performed on the video content is obtained, the determination unit changes the display order such that a video content having a relationship with the video content is displayed after the video content.

9. The distribution apparatus according to claim 1, wherein the distribution unit distributes video content whose display order is determined by the determination unit, according to user's viewing conditions for a video content being displayed in the display frame.

10. The distribution apparatus according to claim 9, wherein when a user has viewed a video content being displayed in the display frame, for a predetermined period of time or more of required time for the video content, the distribution unit distributes video contents whose display order is determined by the determination unit, on a per predetermined number of video contents basis.

11. A distribution method performed by a computer, the distribution method comprising:
accepting submission of video content to be displayed in a predetermined content display frame;
determining display order of the video content based on information indicating users' reactions to the video content accepted by the accepting; and
distributing the video content such that the video contents are displayed in the display order determined by the determining.

12. A non-transitory computer readable storage medium having stored therein a distribution program causing a computer to perform:
accepting submission of video content to be displayed in a predetermined content display frame;
determining display order of the video content based on information indicating users' reactions to the video content accepted by the accepting; and
distributing the video content such that the video content are displayed in the display order determined by the determining.
